(19) United States
(12) Patent Application Publication
(10) Pub. No.: US 2015/0133130 A1
(43) Pub. Date: May 14, 2015

(54) MULTI-SIM SMALL CELL FINGERPRINTING

(71) Applicant: Broadcom Corporation, Irvine, CA (US)

(72) Inventors: Sudip Alexei Gupta, Hertfordshire (GB); Abhishek Pandit, Berkshire (GB); Navin Kumar KARRA, Berkshire (GB); Stephen James Richards, Berks (GB)

(21) Appl. No.: 14/088,703

(22) Filed: Nov. 25, 2013

Related U.S. Application Data
(60) Provisional application No. 61/902,609, filed on Nov. 11, 2013.

(51) Int. Cl. H04W 48/16; H04W 24/00; H04W 88/06; H04W 76/02

(52) U.S. Cl. CPC H04W 48/16; H04W 76/025; H04W 24/00; H04W 88/06
USPC 455/450; 455/553.1

(57) ABSTRACT

Aspects of multi-subscriber identification module (SIM) small cell fingerprinting are described. In one embodiment, a first communication link is established with a first macro cell for a first communications service, and a second communication link is established with a second macro cell for a second communications service. Further, access neighborhoods of the first and second communications services are measured. Using the access neighborhood measurements, a fingerprint for a small cell may be generated. In this manner, fingerprints for various small cells may be generated, where each fingerprint includes measurement and/or positional data from two or more access networks of different communications services. Proximity to a small cell may be detected more reliably when using such fingerprints, because the fingerprints include measurement and/or positional data from two or more access networks.

### CROSS-REFERENCE TO RELATED APPLICATIONS

This application claims the benefit of U.S. Provisional Application No. 61/902,609, filed Nov. 11, 2013, the entire contents of which is hereby incorporated herein by reference.

### BACKGROUND

Certain user equipment devices and chipsets support multi-subscriber identity module (SIM) cards. Such devices are equipped with multiple SIM card slots, and each SIM card may be associated with a respective cellular communications service and service provider. Further, certain multi-SIM capability devices support wireless communication over different types of cellular access stations, such as macro cells, small cells, micro cells, etc. Generally, the communications range for a base station macro cell may be between 20-25 miles, with small cells and micro cells providing smaller coverage areas.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 illustrates a multi-SIM system according to an example embodiment.

FIG. 2 illustrates a network deployment including macro cells and small cells according to an example embodiment.

FIG. 3 illustrates a network deployment for multi-SIM small cell fingerprinting which includes network neighborhoods for first and second communications services according to an example embodiment.

FIG. 4 illustrates a user equipment device used in the network deployment of FIG. 3 according to an example embodiment.

FIG. 5 illustrates a process of multi-SIM small cell fingerprinting performed by the user equipment device of FIG. 4 according to an example embodiment.

FIG. 6 illustrates a process of proximity detection using fingerprints performed by the user equipment device of FIG. 4 according to an example embodiment.

FIG. 7 illustrates a process of small cell selection using fingerprints performed by the user equipment device of FIG. 4 according to an example embodiment.

FIG. 8 illustrates another process of small cell selection using fingerprints performed by the user equipment device of FIG. 4 according to an example embodiment.

FIG. 9 illustrates a process of macro cell selection using fingerprints performed by the user equipment device of FIG. 4 according to an example embodiment.

FIG. 10 illustrates a process of calculating confidence in proximity using fingerprints performed by a fingerprint controller of the user equipment device of FIG. 4 according to an example embodiment.

FIG. 11 illustrates an example schematic block diagram of a computing architecture which may be employed by a user equipment device described herein according to various embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions or positions of elements and features may be exaggerated to help visually convey certain principles. In the drawings, similar reference numerals between figures designate like or corresponding, but not necessarily the same, elements.

### DETAILED DESCRIPTION

In the following paragraphs, various embodiments are described in further detail by way of example with reference to the attached drawings. In the description, well known components, methods, and/or processing techniques are omitted or briefly described so as not to obscure the embodiments.

As outlined above, multi-SIM capable user equipment (UE) devices support wireless communication with multiple cellular services and/or service providers. Further, these UE devices may support wireless communication with different types of cellular access stations, such as macro cells, small cells, micro cells, etc. In this case, the UE devices should be optimized to perform communication link handoffs among macro cells and small cells, for example, for the supported cellular services and service providers.

In this context, aspects of the embodiments described herein are related to improvements in the accuracy of proximity detection for small cells, even in the presence of parameter changes in communications networks. Further, in the context of UE devices which operate in dual SIM dual standby (DSDS) mode, improvements in proximity detection for suspended modems using measurements from active modems are described. Additionally, according to the features of the embodiments described herein, one or more modems in a multi-SIM capable UE device may be able to establish communications with a small cell using less energy and time, and resume communications with one or more macro cells or small cells more quickly after resuming from a suspended mode.

Turning now to the drawings, a description of exemplary embodiments of systems and system elements are provided, followed by a discussion of the operation of the same.

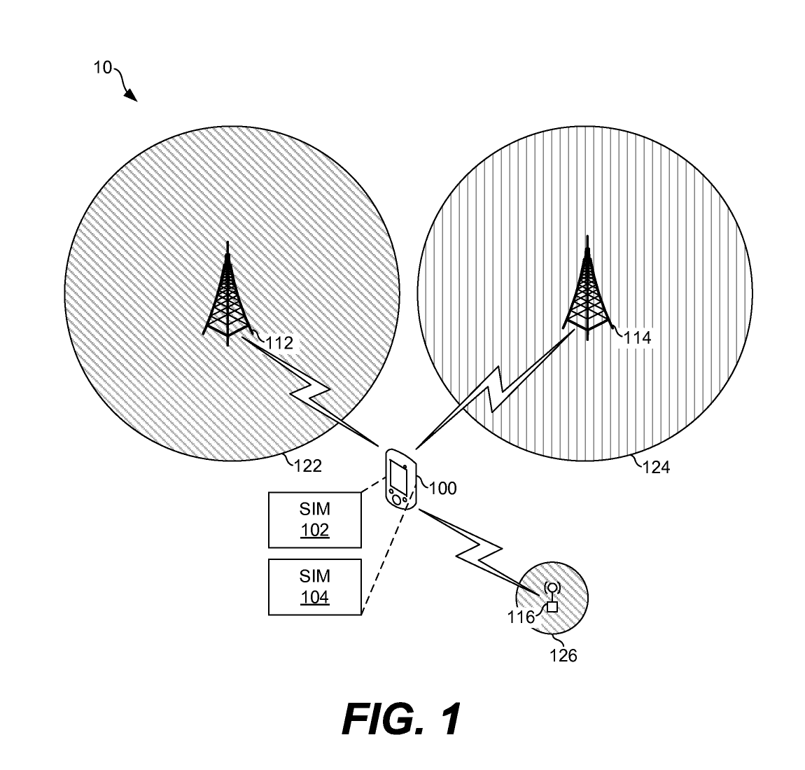

FIG. 1 illustrates a multi-SIM system 10 according to an example embodiment. The system 10 includes a UE device 100, a macro cell 112 for a first communications service, a macro cell 114 for a second communications service, and a small cell 116 for the first communications service. The macro cell 112 includes a coverage area 122, the macro cell 114 includes a coverage area 124, and the small cell 116 includes a coverage area 126. The UE device 100 is embodied as a multi-SIM capable UE device, and includes a first SIM card 102 for access to the first communications service and a second SIM card 104 for access to the second communications service. It is noted that the elements of the system 10 and the relative positions of the elements in the system 10 are not drawn to scale. For example, the coverage areas 122, 124, and 126 may vary in size, are representative, and are not intended to be limiting in nature.

It should be appreciated that the first communications service may be embodied by a network of macro cells, including the macro cell 112 and other macro cells, which embody an access neighborhood of the first communications service. Similarly, the second communications service may be embodied by a network of macro cells, including the macro cell 114 and other macro cells, which embody an access neighborhood of the second communications service.

The small cell 116 may be embodied as a cellular access point that provides a coverage area smaller than that of a macro cell (e.g., either the macro cells 112 or 114). The coverage area may be smaller in terms of geographic coverage and/or the number of UE devices which may be supported by the small cell 116, for example. The small cell 116 may be relied upon to extend the reach or bolster the coverage area of the first communications service. For example, the small cell 116 may be installed indoors, such as in a house, an office building, a warehouse, or in a shopping mall, where the coverage provided by the macro cell 112 may be intermittent. Similarly, the small cell 116 may be installed at sporting venues, transportation terminals, or theme parks, for example, where the coverage provided by the macro cell 112 may be overloaded. As described herein, small cells may encompass femtocells, picocells, microcells, and other related types of access points. Such small cells may provide radio coverage footprints ranging from 10 meters for in-building installations to 2 kilometers for rural installations, for example. In some cases, a small cell may be embodied as a closed subscriber group (CSG) access point. In this case, access to the communications service provided by the CSG may be limited to certain users, groups of users, or based on other parameters.

The macro cells 112 and 114 may broadcast control channels which are used by the UE device 100 to establish communication links with the macro cells 112 and 114 and, respectively, the first and second communications services. The control channels may include broadcast control channels (BCCHs), for example, which identify and describe the configuration and available features of the macro cells 112 and 114. The control channels may also provide a list of base station identification codes (BSICs), Primary Scrambling Codes (PSCs) and/or Physical Cell IDs (PCIDs), as well as corresponding channel numbers associated with neighboring (i.e., geographically adjacent or proximate) base stations or macro cells. That is, the control channels may be relied upon by the UE device 100 to retrieve a neighbor cell list including BSICs/PSCs/PCIDs and radio frequency (RF) channel numbers (RFCNs) used by neighboring macro cells. In this context, the macro cells 112 and 114 may maintain and broadcast a BCCH Allocation List (i.e., BA list) including a list of frequencies of neighboring cells. The BA list may be relied upon by the UE device 100 to estimate signal strength and/or signal quality measurements for channels available on neighboring macro cells, and to determine when to reselect, handover, or handoff a communications link to a neighboring macro cell.

It is noted that, although neighbor cell lists may include lists of BSICs/PCIDs/PSCs and RFCNs used by macro cells neighboring the macro cells 112 and 114, the neighbor lists may not identify the small cell 116 or the RF channel(s) associated with the small cell 116. In other words, even if the small cell 116 is positioned within or proximate to the coverage area 122 of the macro cell 112, the neighbor cell list provided by the macro cell 112 may not identify the small cell 116 as a neighboring cell. In this context, it is noted that, although the UE device 100 may rely on neighbor cell lists to establish and/or handoff communications links among neighboring macro cells, the UE device 100 may need to rely upon other means to identify small cells available for establishing communications links. Because the UE device 100 in FIG. 1 may not be able to rely on a neighbor cell list broadcast from the macro cell 112 to identify the small cell 116, the UE device 100 may need to manually detect and locate small cells. In this context, the detection of the small cell 116 by the UE device 100 may depend upon search and detection protocols which consume a significant amount of time and power for the UE device 100.

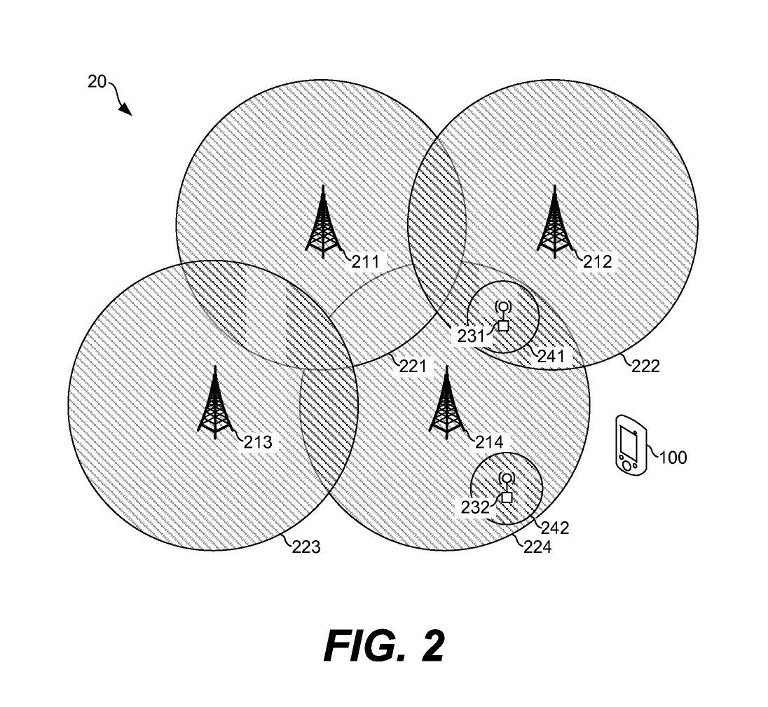

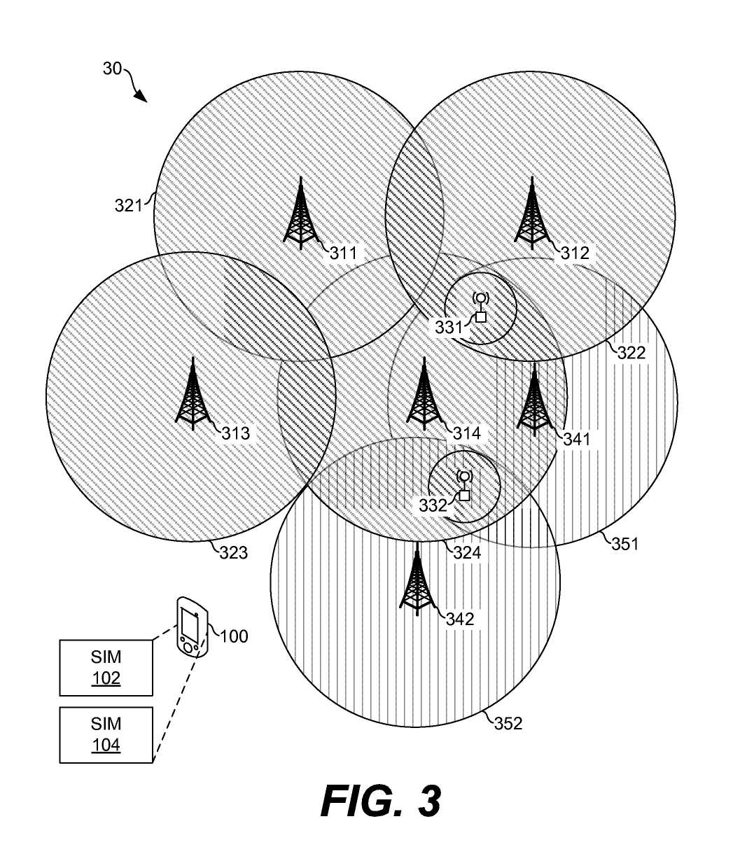

According to aspects and features of the embodiments described herein, the search for and detection of small cells by the UE device 100 may be improved through a combination of fingerprinting and proximity detection algorithms that gather and review positioning data. For example, certain positioning data may be gathered and stored as a fingerprint for the small cell 116, when the UE device 100 establishes a communication link with the small cell 116. Subsequently, positioning data which is gathered by the UE device 100 over time may be compared with attributes of the fingerprint for the small cell 116, to detect proximity to the small cell 116. In various embodiments, the positioning data may include global navigation satellite system (GNSS), Wi-Fi (i.e., 802.11) signal strength levels and network identifiers, and access neighborhood measurement data, for example. In the embodiments described herein, because the UE device 100 is embodied as a multi-SIM capable UE device, the UE device 100 may gather neighborhood measurement data for one or more communications services. As further described below with reference to FIGS. 2 and 3, the accuracy in detection of small cells may be improved based on access neighborhood measurements from two or more communications services.

FIG. 2 illustrates a network deployment 20 including macro cells and small cells according to an example embodiment. The network deployment 20 includes macro cells 211-214, respectively, having coverage areas 221-224. The network deployment 20 also includes small cells 231 and 232, respectively, having coverage areas 241 and 242. The UE device 100 may establish a communication link with any of the macro cells 211-214 or the small cells 231 and 232, depending upon the relative position of the UE device 100 among the macro cells 211-214 or the small cells 231 and 232. For various reasons, it may be preferable for the UE device 100 to establish a communication link with one of the small cells 231 or 232, so long as the UE device 100 is within a threshold proximity to one of the small cells 231 or 232.

The UE device 100 may determine proximity to one of the small cells 231 or 232 based on a proximity detection algorithm. As described above, proximity detection algorithms may rely on positioning data, such as GNSS, Wi-Fi signal strength levels and network identifiers, and radio access network (RAN) measurement data, for example. Of these types of data, it is noted that the UE device 100 may gather access neighborhood measurements as part of standard cellular protocols and procedures. In this sense, it is not necessary for a UE device to expend additional power to gather access neighborhood measurements. On the other hand, GNSS and Wi-Fi services, as incorporated in the UE device 100, may be enabled only when necessary and, in general, require additional power consumption. Thus, for low power consumption, for example, access neighborhood measurements are relied upon in the embodiments described herein for proximity detection and fingerprinting.

Access neighborhood measurements may be used to triangulate the position of the UE device 100 in the network deployment 20 and, when the UE device 100 establishes a communication link with one of the small cells 231 or 232, the triangulation measurements may be stored in the UE device 100 as a fingerprint for the small cell. In turn, the next time that the UE device 100 encounters a similar triangulation measurement, the UE device 100 may assume that it is within a certain proximity to the small cell. However, triangulation measurements may not be particularly helpful for every small cell, depending upon coverage of the network deployment 20. For example, as illustrated in FIG. 2, it may not be possible to accurately triangulate a location associated with the small cell 231, because the small cell 231 overlaps with the coverage areas of only two macro cells, macro cells 212 and 214. Further, it may not be possible to accurately triangulate a location associated with the small cell 232, because the small cell 232 overlaps with the coverage area of only the macro cell 214. Generally, service providers may seek to avoid extensive overlapping in coverage areas among macro cells, as the overlap may be inefficient and ineffective.

Thus, in the case of the network deployment 20, the UE device 100 may seek to improve the proximity detection afforded by access neighborhood measurements by using additional positioning data, such as GNSS and/or Wi-Fi positioning data, for example. Additionally or alternatively, the UE device 100 may perform periodic searches for small cells in an effort to identify them. Gathering such additional positioning data and performing periodic small cell searches, however, impacts power usage and may interfere with other operations of the UE device 100. In the context of these examples, it is noted that, if access neighborhood measurements are introduced from a second communications network and/or service, then the UE device 100 can increase the accuracy of its proximity detection algorithms with additional access neighborhood measurements.

FIG. 3 illustrates a network deployment 30 for multi-SIM small cell fingerprinting which includes network neighborhoods for first and second communications services according to an example embodiment. The network deployment 30 includes macro cells 311-314, respectively, having coverage areas 321-324. The network deployment 30 further includes macro cells 341 and 342, respectively, having coverage areas 351 and 352. The macro cells 311-314 may provide a first communications service from a first service provider, and the macro cells 341 and 342 may provide a second communications service from a second service provider. The network deployment 30 also includes small cells 331 and 332 of the first service provider.

Because the UE device 100 is embodied as a multi-SIM capable UE device, the UE device 100 may establish one or more communication links with the macro cells 311-314, 341, and 342, and the small cells 331 and 332. Particularly, the UE device 100 may establish a first communication link with one of the macro cells 311-314 or the small cells 331 and 332 using the first SIM card 102, and establish a second communication link with the macro cells 341 and 342 using the second SIM card 104. Further, the UE device 100 may gather access neighborhood measurements for both the network deployments of the first communications service (e.g., the macro cells 311-314) and the second communications service (e.g., the macro cells 341 and 342).

For example, access neighborhood measurements for both the first and second communications services may be used in combination to triangulate the position of the UE device 100 and, when the UE device 100 establishes a communication link with a small cell, the combined triangulation measurements may be incorporated into a fingerprint for the small cell. In turn, the next time in which the UE device 100 encounters a similar triangulation measurement, the UE device may assume that it is within a certain proximity to the small cell.

As compared to the examples in FIG. 2, with access neighborhood measurements for both the first and second communications services, it is possible to more accurately triangulate locations for both the small cells 331 and 332. Particularly, the small cell 331 overlaps not only with the coverage areas of the macro cells 312 and 314, but also with the coverage area of the macro cell 341. Further, the small cell 332 overlaps not only with the coverage area of the macro cell 314, but also with the coverage areas of the macro cells 341 and 342. With reference to the network topology 30 in FIG. 3, it is apparent how neighborhood measurements from multiple communications services may be relied upon to benefit proximity detection and fingerprinting for small cells.

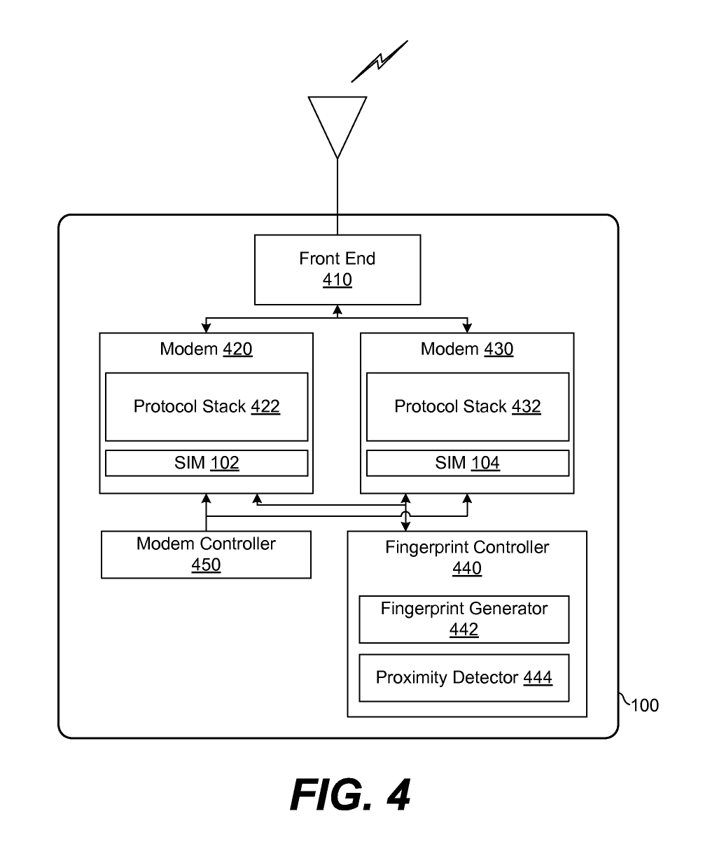

FIG. 4 illustrates the UE device 100 used in the network deployment 30 of FIG. 3 according to an example embodiment. The UE device 100 includes a front end 410, a first modem 420, a second modem 430, a fingerprint controller 440, and a modem controller 450. It should be appreciated that the elements of the UE device 100 are described and illustrated by way of example and not limitation, and the UE device 100 may include other elements consistent with a UE device for Global System for Mobile Communications (GSM), Code Division Multiple Access (CDMA), Universal Mobile Telecommunications System (UMTS), and/or Long Term Evolution (LTE) communications, for example.

The front end 410 may be embodied as one or more general- or specific-purpose processors or processing circuits, one or more analog-to-digital converter (ADC) circuits, digital-to-analog converter (DAC) circuits, amplifiers, filters, etc., for a physical layer front end chain of a cellular communications radio. The first modem 420 includes a protocol stack 422 and the first SIM 102, and the second modem 430 includes a protocol stack 432 and the second SIM 104. Generally, the first and second modems 420 and 430 are configured to modulate and demodulate data upon carriers for transmission and reception via the front end 410, and may support telephony and other data transfer between the UE device 100 and first and second communications services. The protocol stacks 422 and 432 may supervise, implement, and control the protocol requirements for the first and second communications services, to ensure suitable data transfer by the UE device 100 over the first and second communications services. The first and second modems 420 and 430 may be embodied as one or more general- or specific-purpose processors or processing circuits.

It is noted that some UE devices, such as the UE device 100, include one RF front end chain for the modems 420 and 430. In the embodiment of the UE device 100 illustrated in FIG. 4, the modems 420 and 430 share the RF front end 410. Thus, the UE device 100 may operate in a dual SIM dual standby (DSDS) mode. In other embodiments, the UE device 100 may include separate RF front ends for each of the modems 420 and 430. A dual SIM UE device with dedicated RF front ends may operate in dual SIM dual active (DSDA) mode, and may manage simultaneous calls using two SIM cards.

In DSDS mode, both of the modems 420 and 430 of the UE device 100 may standby for incoming calls from respective service providers. Once a call is established, however, the UE device 100 suspends one of the modems 420 and 430 while the other is active. In the DSDS configuration illustrated in FIG. 4, the modem controller 450 arbitrates access to the RF front end 410 for the modems 420 and 430. For example, before setting up a new call, the first modem 420 may request access to the RF front end 410 from the modem controller 450. Similarly, the second modem 430 may request access to the RF front end 410 from the modem controller 450 before performing certain operations. The modem controller 450 may permit or deny, admit or reject access to the RF front end 410 in response to a request from one modem, depending upon the circumstances surrounding the request and, for example, the expected and ongoing operations of the other modem. The modem controller 450 may be embodied as one or more general- or specific-purpose processors or processing circuits.

The fingerprint controller 440 receives access neighborhood measurements for various communications services. For example, in the dual SIM capable UE 100, the fingerprint controller 440 may receive access neighborhood measurements associated with a first communications service from the first modem 420 and receive access neighborhood measurements associated with a second communications service from the second modem 430. With reference to the network deployment 30 of FIG. 3, the fingerprint controller 440 may receive measurements for the macro cell 314 and the neighboring macro cells 311-313, and measurements for the macro cell 341 and the neighboring macro cell 342. In various embodiments, such measurements may be representative of different metrics for each of the macro cells 311-314, 341, and 342, such as signal strength, power, time of arrival, etc., as measured by the UE device 100. It is noted that the fingerprint controller 440 may be embodied as one or more general- or specific-purpose processors or processing circuits.

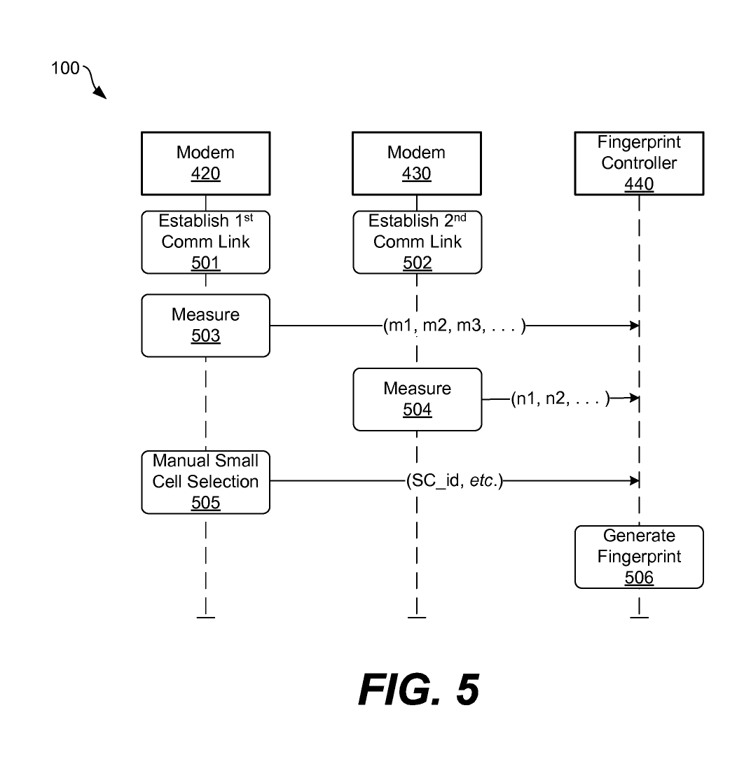

For the dual SIM capable UE 100, the fingerprint generator 442 generates fingerprints associated with small cells, such as the small cells 331 and 332 (FIG. 3), based on, for example, the access neighborhood measurements from the first modem 420 and the access neighborhood measurements from the second modem 430. Each fingerprint may be associated with a certain small cell and include certain attributes and related positioning data, such as an identifier for the small cell, an identifier of a communications service which operates the small cell, and access characteristics or measurements associated with certain macro cells proximate to the small cell, for example. The access characteristics may include signal strength, power, or time of arrival, measurements for proximate macro cells, for example, or combinations thereof, as measured by the UE device 100. In certain embodiments, the fingerprint attributes may further include positioning data such as navigation satellite system (GNSS) data and/or Wi-Fi (i.e., 802.11) signal strength levels and network identifiers. The generation of fingerprints by the fingerprint generator 442 is described in further detail below with reference to FIG. 5.

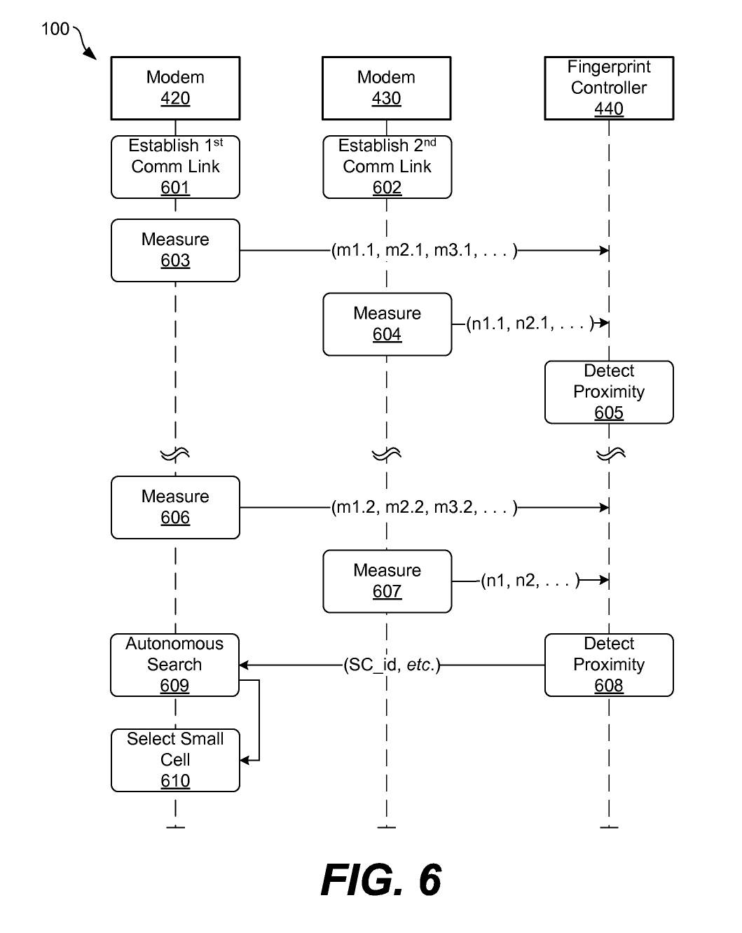

The proximity detector 444 detects proximity to small cells by comparing access neighborhood measurements for first and second communications services with corresponding fingerprints for small cells. In other words, once a fingerprint for a small cell is generated by the fingerprint generator 440, this fingerprint may be relied upon by the proximity detector 444 to determine whether the UE device 100 is within a certain proximity to the small cell. The UE device 100 may then set up, establish, or handoff a communication link with the small cell. The detection of proximity by the proximity detector 444 is described in further detail below with reference to FIGS. 6-9.

Before turning to the process diagrams of FIGS. 5-9, it is noted that the processes described herein may be practiced in an order which is other than that illustrated. That is, the process flows illustrated in FIGS. 5-9 are provided as examples only, and the embodiments may be practiced using process flows that differ from those illustrated. Additionally, it is noted that one or more steps in the processes may be omitted or replaced. Further, steps may be performed in different orders, in parallel with one another, or omitted entirely, and/or certain additional steps may be performed without departing from the scope and spirit of the embodiments. Also, it is noted that, while the process diagrams of FIGS. 5-9 are described in connection with the network topology 30 in FIG. 3 and the UE device 100 in FIG. 4, the processes may be used in connection with other network topologies and UE devices.

FIG. 5 illustrates a process of multi-SIM small cell fingerprinting performed by the UE device 100 of FIG. 4 according to an example embodiment. At reference numeral 501, the process includes establishing a first communication link with a first macro cell for a first communications service. For example, the UE device 100 may establish a communication link with the macro cell 314 (FIG. 3) using the modem 420 (FIG. 4). At reference numeral 502, the process includes establishing a second communication link with a second macro cell for a second communications service. For example, the UE device 100 may establish a communication link with the macro cell 341 (FIG. 3) using the modem 430 (FIG. 4).

At reference numeral 503, the process includes measuring an access neighborhood of the first communications service. For example, the UE device 100 may receive a BA list for the neighborhood of macro cells associated with the first communications service from a control channel of the macro cell 314. Using this BA list, the UE device 100 may identify one or more of the macro cells 311-313 (or other macro cells) as being neighbors of the macro cell 314. In turn, using the front end 410 and/or the modem 420, the UE device 100 may take signal strength, power, time of arrival, or other measurements in connection with the frequency channels supported by the macro cells 311-313. These measurements (e.g., m1, m2, m3, . . . , etc.) may be provided to the fingerprint controller 440 of the UE device 100. It is noted that, depending upon the number of neighboring macro cells in the neighborhood of the macro cell 314, for example, the number of measurements may vary.

At reference numeral 504, the process includes measuring an access neighborhood of the second communications service. For example, the UE device 100 may receive a BA list for the neighborhood of macro cells associated with the second communications service from a control channel of the macro cell 341. Using this BA list, the UE device 100 may identify the macro cell 342 (or other macro cells) as being neighbors of the macro cell 341. In turn, using the front end 410 and/or the modem 430, the UE device 100 may take signal strength, power, time of arrival, or other measurements in connection with the frequency channels supported over the macro cell 342. These measurements (e.g., n1, n2, . . . , etc.) may be provided to the fingerprint controller 440 of the UE device 100. It is noted that, depending upon the number of neighboring macro cells in the neighborhood of the macro cell 342, for example, the number of measurements may vary.

At reference numeral 505, the process includes manually selecting a small cell. Here, a user of the UE device 100 may instruct the UE device 100 to perform a manual search for small cells. This search may identify the small cell 331 (FIG. 3), for example, as being available for establishing a communication link. The user may select the small cell 331 and, in doing so, instruct the UE device 100 to establish a communication link with the small cell 331. In turn, after the communication link is properly established, at reference numeral 505, the process includes triggering the creation of a fingerprint associated with the small cell 331. Particularly, after establishing the communication link with the small cell 331, the modem 420 may provide identifying information for the small cell 331 to the fingerprint controller 440. The identifying information may include an identifier of the small cell and an identifier of the first communications service (e.g., service operator or public network operator ID).

At reference numeral 506, the process includes generating a fingerprint for a small cell for the first communications service based on the access neighborhood of the first communications service and the access neighborhood of the second communications service. For example, the fingerprint generator 444 of the fingerprint controller 440 may generate and store a fingerprint for the small cell 331 based on the access neighborhood measurements of the first communications service (e.g., m1, m2, m3, . . . , etc.) and the access neighborhood of the second communications service (e.g., n1, n2, . . . , etc.). In certain embodiments, the fingerprint for the small cell 331 may also include positioning data attributes such as global navigation satellite system (GNSS) data and/or Wi-Fi (i.e., 802.11) signal strength levels and network identifiers, for example.

Once a fingerprint is generated, it is stored for later use by the fingerprint controller 440. For example, the fingerprints include attributes which may be relied upon by the proximity detector 444 to ascertain a level of confidence in whether the UE device 100 is within a certain proximity to one or more small cells. Thus, as the UE device 100 moves geographically, the proximity detector 444 of the fingerprint controller 440 may be able to identify when the UE device 100 is proximate to the small cell 331, for example, without user intervention being required. In other words, the UE device 100 may establish a communication link with the small cell 331 based on a proximity control signal from the fingerprint controller 440, without the need for a manual search for and/or selection of the small cell 331 by a user. Further, the communication link may be established with the small cell 331 without the need for the additional power and time requirements for a manual search and/or selection.

It is noted that, in various embodiments, the fingerprint controller 440 may generate and store one or more fingerprints for each small cell. Further, the one or more fingerprints for any given small cell may be adjusted or updated over time, for example, such as each time the UE device 100 establishes a communication link with the small cell. In this context, the one or more fingerprints may include statistical averages of measurements taken over time. In some cases, fingerprints may be replaced or deleted, as needed, depending upon changes in network topologies.

FIG. 6 illustrates a process of proximity detection using fingerprints performed by the UE device 100 of FIG. 4 according to an example embodiment. In FIG. 6, the processes at reference numerals 601, 602, 603, and 604 are similar, respectively, to the processes at reference numerals 501, 502, 503, and 504 in FIG. 5. At reference numeral 605, the process includes detecting proximity to a small cell by comparing the access neighborhood of the first communications service (e.g., m1.1, m2.1, m3.1, . . . , etc.) and the access neighborhood of the second communications service (e.g., n1.1, n2.1, . . . , etc.) with fingerprints for small cells. In the context of the network deployment 30 in FIG. 3 and the UE device 100 in FIG. 4, the proximity detector 444 of the fingerprint controller 440 may detect proximity to one or more of the small cells 331 and 332 by comparing the access neighborhood of the first communications service (e.g., m1.1, m2.1, m3.1, . . . , etc.) and the access neighborhood of the second communications service (e.g., n1.1, n2.1, . . . , etc.) with the fingerprints for the small cells 331 and 332 (e.g., as generated according to the process in FIG. 5).

It should be appreciated that the modems 420 and 430 may routinely provide measurements on access neighborhoods over time. The measurements may be taken periodically, for example, or according to a certain schedule, operating parameters, or considerations. Further, the proximity detector 444 may routinely detect for proximity with small cells periodically, for example, or according to a certain schedule, operating parameters, or considerations. Thus, even if, at reference numeral 605, the proximity detector 444 does not detect proximity to a small cell, the process of proximity detection using fingerprints may continue.

Referring again to FIG. 6, the processes at reference numerals 606 and 607 are similar, respectively, to the processes at reference numerals 603 and 604, although new or updated measurements (e.g., m1.2, m2.2, m3.2, . . . , etc., and n1.2, n2.2, . . . , etc.) are provided. At reference numeral 608, the process includes detecting proximity to a small cell, again, by comparing the updated measurements on the access neighborhood of the first communications service (e.g., m1.2, m2.2, m3.2, . . . , etc.) and the updated measurements on the access neighborhood of the second communications service (e.g., n1.2, n2.2, . . . , etc.) with fingerprints for small cells. Here, the proximity detector 444 of the fingerprint controller 440 may detect proximity to one or more of the small cells 331 and 332 by comparing the updated measurements on the access neighborhood of the first communications service (e.g., m1.2, m2.2, m3.2, . . . , etc.) and the updated measurements on the access neighborhood of the access neighborhood of the second communications service (e.g., n1.2, n2.2, . . . , etc.) with the fingerprints for the small cells 331 and 332.

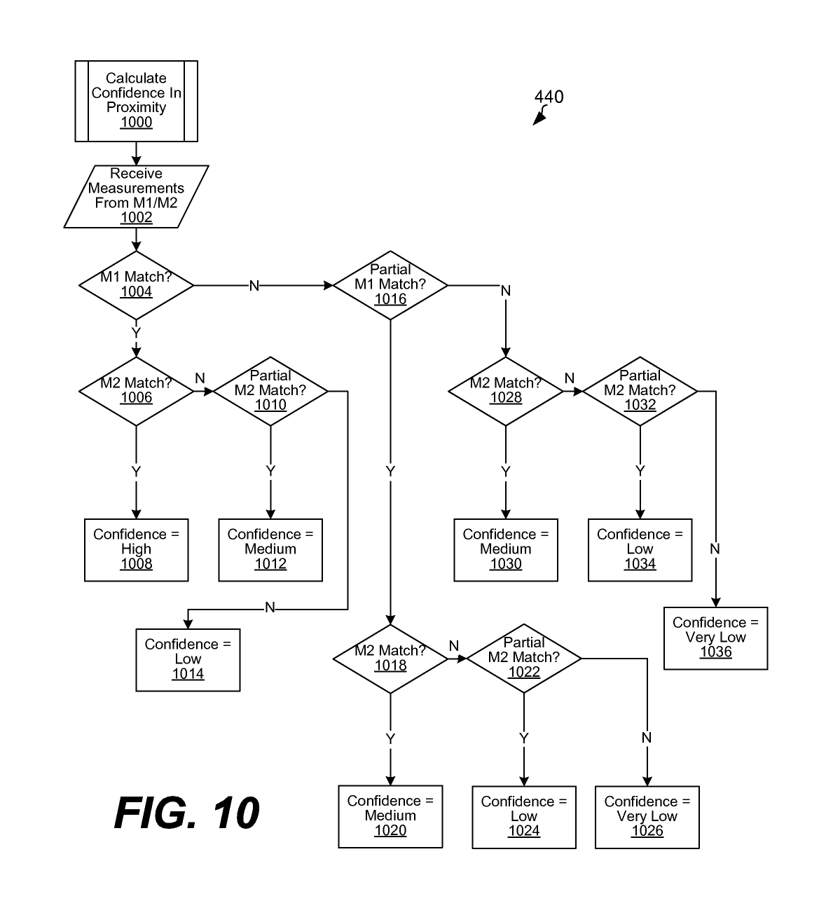

As illustrated in FIG. 6, when proximity to a small cell is detected at reference numeral 608, the process includes prompting a search for and, perhaps, setting up, establishing, or handing off a communication link with the small cell. As illustrated, when proximity to a small cell is detected at reference numeral 608, the fingerprint controller 440 provides an identifier of the small cell to the modem 420 and prompts the modem 420 to perform an autonomous search for the small cell. Aspects of confidence in proximity detection and an example process for ascertaining confidence in proximity detection is described in further detail below with reference to FIG. 10.

In turn, at reference numeral 609, the modem 420 performs the autonomous (i.e., non-manual, automatically-prompted, etc.) search for the small cell identified by the fingerprint controller 440. Upon verifying the identity and proximity to the small cell, the modem 420 sets up, establishes, or hands off a communication link with the small cell at reference numeral 610. That is, depending upon the present operating needs and conditions of the UE device 100, the modem 420 may set up a communication link with the small cell (e.g., discover and negotiate operating parameters, configure the protocol stack, configure filters, etc.), establish the communication link (e.g., commence data communications), and/or hand off a communication link (e.g., transition the link from a macro cell to the small cell).

Generally, according to aspects of the process of proximity detection using fingerprints, power may be conserved in a UE device. Further, the UE device may operate more seamlessly to establish communication links with small cells, without the need for user intervention. The accuracy and confidence in proximity detection is aided based on the availability of access neighborhood measurements from different communications services and/or service providers.

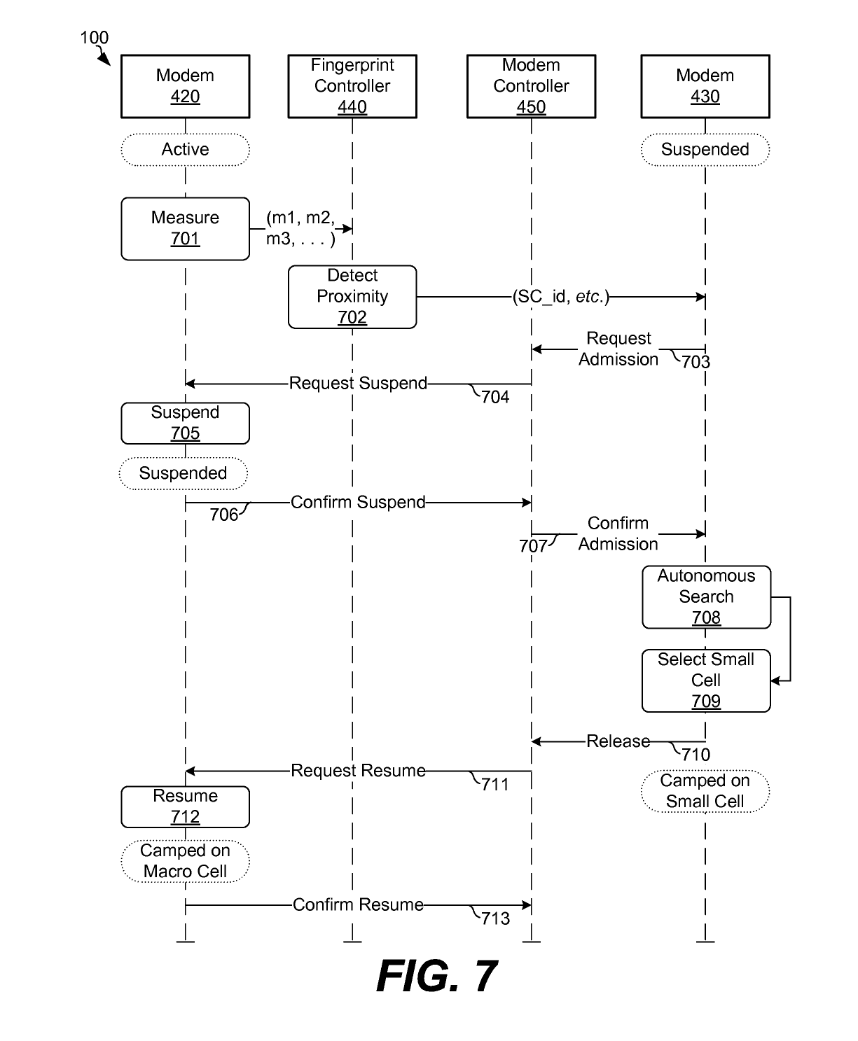

FIG. 7 illustrates a process of small cell selection using fingerprints performed by the UE device 100 of FIG. 4 according to an example embodiment. It should be appreciated that the process illustrated in FIG. 7 is applicable to dual SIM dual standby mode UE devices. That is, the process is applicable to UE devices which include two modems but share a common RF front end chain, as illustrated for the UE device 100 in FIG. 4, for example. However, it should be appreciated that the process may be extended to other multi-SIM standby mode devices.

At the outset in FIG. 7, the modem 420 is active and has access to the RF front end 410 (FIG. 4), and the modem 430 is inactive and in a suspended state. At reference numeral 701, the process includes measuring an access neighborhood of a first communications service, which may be a service associated with the first modem 420. At reference numeral 702, the process includes detecting proximity to a small cell for a second communications service, which may be a service associated with the second modem 430. At reference numeral 702, the detecting proximity may include comparing the access neighborhood of the first communications service (e.g., as measured at reference numeral 701) with fingerprints for small cells, wherein the fingerprints for the small cells include attributes related to access neighborhoods of the first and second communications services.

In this case, although the second modem 430 is suspended, because the fingerprint controller 440 has generated and stored fingerprints including measurement attributes for both the first and second communications services, proximity to a small cell for one of the services may be detected even if a modem associated with that service is suspended. That is, using the fingerprints described herein, proximity to a small cell for one communications service may be detected based on access neighborhood measurements for another communications service.

At reference numeral 702, because proximity to a small cell for the second communications service is detected, the process includes prompting a search for the small cell. For example, at reference numeral 702, the fingerprint controller 440 provides an identifier of the small cell to the modem 430, and prompts the modem 430 to perform an autonomous search for the small cell. In turn, at reference numeral 703, the process includes requesting admission to operate an RF front end. For example, the second modem 430 may request admission to operate the RF front end 410 from the modem controller 450.

In response to the request at reference numeral 703, at reference numeral 704, the process includes requesting the first modem to suspend operation. For example, the modem controller 450 may request the modem 420 to enter a suspended state. At reference numeral 705, the modem 420 may enter the suspended state and, at reference numeral 706, the modem 420 may confirm the suspended state with the modem controller 450. At reference numeral 707, the modem controller 450 may confirm the admission of the second modem 430 to operate the RF front end 410.

In turn, at reference numeral 708, the modem 430 performs the autonomous search for the small cell identified by the fingerprint controller 440 at reference numeral 702. Upon verifying the identity and proximity to the small cell, the modem 430 sets up, establishes, or hands off a communication link with the small cell at reference numeral 709. Again, depending upon the present operating needs and conditions of the UE device 100, the modem 430 may set up a communication link with the small cell (e.g., discover and negotiate operating parameters, configure the protocol stack, configure filters, etc.), establish the communication link (e.g., commence data communications), and/or hand off a communication link (e.g., transition the link from a macro cell to the small cell). In one embodiment, after setting up the communication link with the small cell at reference numeral 709, the modem 430 is camped on the small cell.

At reference numeral 710, the process includes releasing the RF front end. That is, the modem 430 indicates to the modem controller 450 that the RF front end 410 is being released. In turn, at reference numeral 711, the process includes requesting the first modem to resume operation with the RF front end. Further, at reference numeral 712, the process includes resuming operation of the RF front end by the first modem, and confirming the resumed operation at reference numeral 713. In the context of the UE device 100, the first modem 420 may resume operation of the RF front end 410 at reference numeral 712, and confirm the resumed operation with the modem controller 450 at reference numeral 713. In one embodiment, after resuming the operation of the RF front end 410 at reference numeral 713, the modem 430 may be camped on a macro cell.

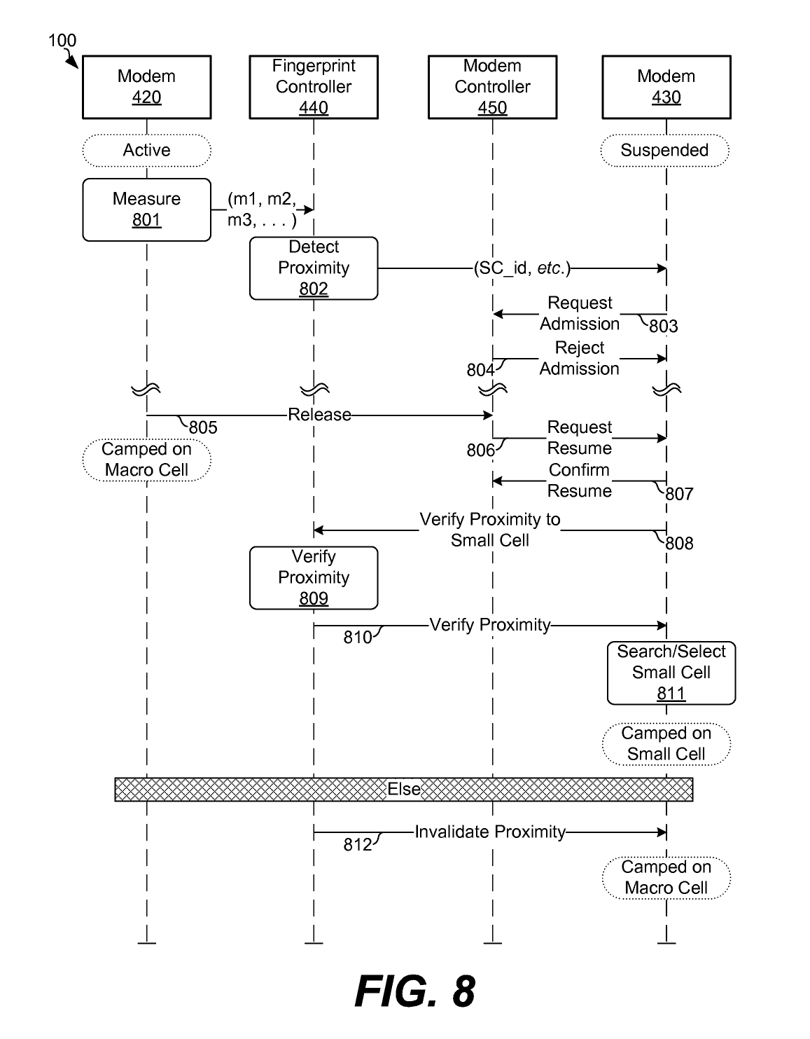

FIG. 8 illustrates another process of small cell selection using fingerprints performed by the UE device 100 of FIG. 4 according to an example embodiment. At the outset in FIG. 8, the modem 420 is active and has access to the RF front end 410 (FIG. 4), and the modem 430 is inactive and in a suspended state. At reference numeral 801, the process includes measuring an access neighborhood of a first communications service, which may be a service associated with the first modem 420. At reference numeral 802, the process includes detecting proximity to a small cell for a second communications service, which may be a service associated with the second modem 430. At reference numeral 802, the detecting proximity may include comparing the access neighborhood of the first communications service (e.g., as measured at reference numeral 801) with fingerprints for small cells, wherein the fingerprints for the small cells include attributes related to access neighborhoods of the first and second communications services.

At reference numeral 802, because proximity to a small cell for the second communications service is detected, the process includes prompting a search for the small cell. For example, at reference numeral 802, the fingerprint controller 440 provides an identifier of the small cell to the modem 430, and prompts the modem 430 to perform an autonomous search for the small cell. In turn, at reference numeral 803, the process includes requesting admission to operate an RF front end. For example, the second modem 430 may request admission to operate the RF front end 410 from the modem controller 450.

In response to the request at reference numeral 803, at reference numeral 804, the process includes rejecting admission to operate the RF front end. In this case, if the first modem is busy with the RF front end, and the RF front end cannot be suitably released without negatively impacting the operation of the UE device 100, the modem controller 450 will reject the request for admission by the second modem 430. After some time, however, the process includes the first modem releasing the RF front end at reference numeral 805. In turn, the process includes requesting the second modem to resume operation of the RF front end at reference numeral 806. That is, after the first modem 420 concludes the necessary operations with the RF front end 410, the first modem 420 releases the RF front end 410. Then, the modem controller 450 may request the modem 430 to resume operations with the RF front end 410, and the modem 430 may confirm at reference numeral 807.

At reference numeral 808, the process includes verifying proximity to the small cell. Here, it is noted that, because a significant amount of time may have elapsed since the detection of proximity with the small cell at reference numeral 802, the modem 430 seeks to confirm with the fingerprint controller 440 that the proximity is still valid. In other words, the modem 430 seeks to confirm that the UE device 100 is still located close to the small cell.

In one case, if the proximity is confirmed by the fingerprint controller 440, the fingerprint controller 440 returns a verification of the proximity at reference numeral 810. In turn, at reference numeral 811, the modem 430 performs an autonomous search for the small cell identified by the fingerprint controller 440 at reference numeral 802 and sets up, establishes, or hands off a communication link with the small cell at reference numeral 811. In one embodiment, after setting up the communication link with the small cell at reference numeral 811, the modem 430 is camped on the small cell. In an alternative case, if the proximity is not confirmed by the fingerprint controller 440, the fingerprint controller 440 invalidates the proximity at reference numeral 812. In this case, the modem 430 may remain camped on a macro cell, for example.

According to the process illustrated in FIGS. 7 and 8, transitions from macro cell to small cell may be faster and more seamless, for example, especially in the context of a UE device which operates in DSDA mode. Particularly, even when a first modem is actively using a shared RF front end over a first communications service, proximity to a small cell for a second communications service may be identified. Additionally, a second modem may be admitted access to the RF front end, for example, to set up parameters with the small cell (e.g., camp on the small cell), while awaiting the first modem to conclude operations with the RF front end.

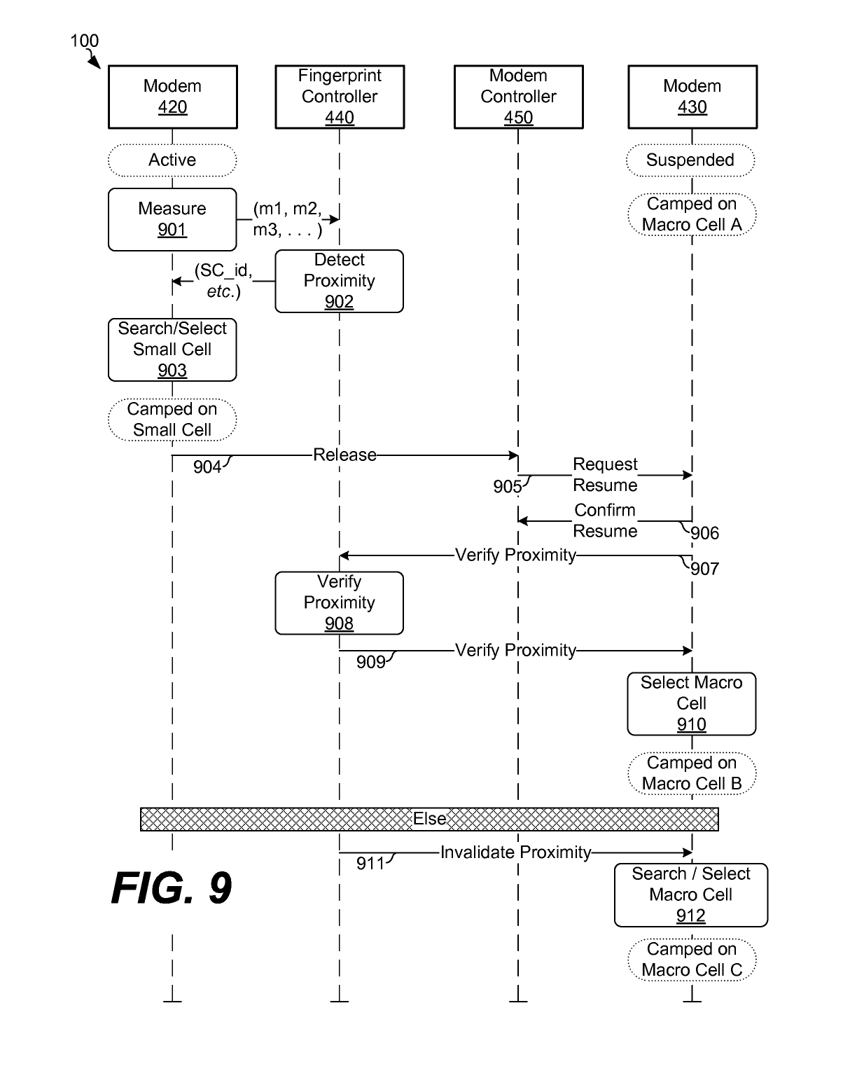

In other aspects of the embodiments, fingerprints may be used to assist with faster and more seamless transitions between macro cells. In this context, FIG. 9 illustrates a process of macro cell selection using fingerprints performed by the UE device 100 of FIG. 4 according to an example embodiment. At the outset in FIG. 9, the modem 420 is active and has access to the RF front end 410 (FIG. 4), and the modem 430 is inactive and in a suspended state. The modem 430 is camped on macro cell A, although suspended. It is noted that, while the modem 430 is suspended, the UE device 100 may be repositioned geographically to a location outside the service area of the macro cell A. In this context, reference to positional data in fingerprints may be used to assist the modem 430 to quickly set up or establish a communication link with a new macro cell, if the UE device 100 has repositioned, upon release of the RF front end 410 by the modem 420.

At reference numeral 901, the process includes measuring an access neighborhood of a first communications service, which may be a service associated with the first modem 420. At reference numeral 902, the process includes detecting proximity to a small cell for the first communications service. At reference numeral 902, the detecting proximity may include comparing the access neighborhood of the first communications service (e.g., as measured at reference numeral 901) with fingerprints for small cells. At reference numeral 902, because proximity to a small cell for the second communications service is detected, the process includes prompting a search for the small cell. For example, at reference numeral 903, the fingerprint controller 440 provides an identifier of the small cell to the modem 420, and prompts the modem 420 to search for and select the small cell. In this case, after selecting the small cell at reference numeral 903, the modem 420 is camped on the small cell.

At reference numeral 904, the process includes releasing the RF front end. That is, the modem 420 indicates to the modem controller 450 that the RF front end 410 is being released. In turn, at reference numeral 905, the process includes requesting the second modem to resume operation with the RF front end, and, at reference numeral 906, the process includes confirming the resumed operation. In the context of the UE device 100, the second modem 430 may resume operation of the RF front end 410 at reference numeral 905, and confirm the resumed operation with the modem controller 450 at reference numeral 906.

In one embodiment, after resuming the operation of the RF front end 410 at reference numeral 905, the modem 430 may need to set up or establish a communication link with a new macro cell, for example, if the UE device 100 has repositioned geographically to a location outside the service area of the macro cell A. Thus, at reference numeral 907, the process includes validating proximity information. Here, a reference numeral 908, the modem 430 may seek to validate and/or retrieve positional data associated with the small cell proximity identified at reference numeral 902. In other words, the modem 430 seeks to confirm that the UE device 100 is still located close to the small cell identified at reference numeral 902.

In one case, if the proximity is confirmed by the fingerprint controller 440, the fingerprint controller 440 returns a verification of the proximity at reference numeral 909. The verification may be accompanied by positional information from a fingerprint associated with the small cell detected at reference numeral 902. As described herein, because small cell fingerprints include access network and other positional data associated with various communications services, the fingerprints may be used as a type of reverse lookup table among the modems 420 and 420. For example, at reference numeral 909, the fingerprint controller 440 may return BA list information (e.g., macro cell frequency channel information) for the second communications service, as it is associated with the location of the small cell detected at reference numeral 902. This BA information may be used by the modem 430, at reference numeral 910, to select a new macro cell (i.e., macro cell B). In this case, it is not necessary for the modem 430 to conduct a new search of the access neighborhood for the second communications service. In an alternative case, if verification of the proximity is not confirmed by the fingerprint controller 440, the fingerprint controller 440 invalidates the proximity at reference numeral 911. In this case, the modem 430 may need to conduct a new search of the access neighborhood for the second communications service and select a new macro cell (i.e., macro cell C) based on the search at reference numeral 912.

FIG. 10 illustrates a process 1000 of calculating confidence in proximity using fingerprints performed by the fingerprint controller 440 of the UE device 100 of FIG. 4 according to an example embodiment. Generally, when detecting proximity to small cells by comparing access measurement data with corresponding access measurement attributes in fingerprints, the process 1000 may be performed to extract a measure of confidence in the detection of proximity.

At reference numeral 1002, the process 1000 includes receiving measurements from first and second modems. For example, the measurements may be similar to the measurements m1, m2, m3, . . . , etc. and n1, n2, . . . , etc. described above with reference to FIG. 5. At reference 1004, the process determines whether the measurements from the first modem match corresponding access neighborhood attributes in a fingerprint for a small cell. If they substantially match, then the process proceeds to reference numeral 1006, where the process determines whether the measurements from the second modem match corresponding ones from the fingerprint. If the measurements from the second modem match those from the fingerprint at reference numeral 1006, then the process proceeds to reference numeral 1008, where the degree of confidence in proximity to the small cell is determined to be high. In other words, at reference numeral 1008, the fingerprint controller 440 has detected proximity to the small cell with a high degree of confidence.

If, at reference 1006, the process determines that the measurements from the second modem do not substantially match corresponding access neighborhood attributes in the fingerprint for the small cell, then the process proceeds to reference numeral 1010, where the process determines whether the measurements from the second modem partially match those from the fingerprint. If the measurements from the second modem partially match those from the fingerprint at reference numeral 1010, then the process proceeds to reference numeral 1012, where the degree of confidence in proximity to the small cell is determined to be medium. In other words, at reference numeral 1012, the fingerprint controller 440 has detected proximity to the small cell with a medium degree of confidence. Alternatively, if the measurements from the second modem do not match those from the fingerprint at reference numeral 1010, then the process proceeds to reference numeral 1014, where the degree of confidence in proximity to the small cell is determined to be low.

In this case, where a good match was confirmed with the measurements from the first modem but the match was not confirmed with the measurements from the second modem, the fingerprint controller 440 may identify that system parameters for the second communications service, which is associated with the second modem, have changed. The change may be due to network configuration changes, for example, made by the service operator or provider of the second communications service. Here, the fingerprint controller 440 may update or replace the fingerprint to reflect the potential for changes in the network configuration.

Referring back to FIG. 10, if, at reference 1004, the process determines that the measurements from the first modem do not substantially match corresponding access neighborhood attributes in the fingerprint for the small cell, then the process proceeds to reference numeral 1016, where the process determines whether the measurements from the first modem partially match the corresponding ones from the fingerprint. If the measurements from the first modem partially match those from the fingerprint at reference numeral 1016, then the process proceeds to reference numeral 1018, where the process determines whether the measurements from the second modem match corresponding ones from the fingerprint. If the measurements from the second modem match those from the fingerprint at reference numeral 1018, then the process proceeds to reference numeral 1020, where the degree of confidence in proximity to the small cell is determined to be medium. In this case, the degree of confidence is somewhat less than was the case at reference numeral 1008.

If, at reference 1018, the process determines that the measurements from the second modem do not substantially match corresponding access neighborhood attributes in the fingerprint for the small cell, then the process proceeds to reference numeral 1022, where the process determines whether the measurements from the second modem partially match those from the fingerprint. If the measurements from the second modem partially match those from the fingerprint at reference numeral 1022, then the process proceeds to reference numeral 1024, where the degree of confidence in proximity to the small cell is determined to be low. In other words, at reference numeral 1024, the fingerprint controller 440 has not detected proximity to the small cell with confidence. Alternatively, if the measurements from the second modem do not match those from the fingerprint at reference numeral 1022, then the process proceeds to reference numeral 1026, where the degree of confidence in proximity to the small cell is determined to be very low.

If, at reference 1016, the process determines that the measurements from the first modem do not partially match corresponding access neighborhood attributes in the fingerprint for the small cell, then the process proceeds to reference numeral 1028, where the process determines whether the measurements from the second modem match corresponding ones from the fingerprint. If the measurements from the second modem match those from the fingerprint at reference numeral 1028, then the process proceeds to reference numeral 1030, where the degree of confidence in proximity to the small cell is determined to be medium. In this case, where a good match was confirmed with the measurements from the second modem but the match was not confirmed with the measurements from the first modem, the fingerprint controller 440 may identify that system parameters for the first communications service, which is associated with the first modem, have changed. The change may be due to network configuration changes, for example, made by the service operator or provider of the first communications service. Here, the fingerprint controller 440 may update or replace the fingerprint to reflect the potential for changes in the network configuration.

If, at reference 1028, the process determines that the measurements from the second modem do not substantially match corresponding access neighborhood attributes in the fingerprint for the small cell, then the process proceeds to reference numeral 1032, where the process determines whether the measurements from the second modem partially match those from the fingerprint. If the measurements from the second modem partially match those from the fingerprint at reference numeral 1032, then the process proceeds to reference numeral 1034, where the degree of confidence in proximity to the small cell is determined to be low. In other words, at reference numeral 1034, the fingerprint controller 440 has not detected proximity to the small cell with confidence. Alternatively, if the measurements from the second modem do not match those from the fingerprint at reference numeral 1032, then the process proceeds to reference numeral 1036, where the degree of confidence in proximity to the small cell is determined to be very low.

It is noted that the process 1000 of calculating confidence in proximity using fingerprints, as illustrated in FIG. 10, is provided by way of example, and the fingerprint controller 440 may obtain measures of confidence in proximity in other ways. Generally, when the proximity detector 444 determines proximity to a small cell by comparing the access neighborhoods of the first and second communications services with the fingerprints stored in the fingerprint controller, if a match to a sufficient degree of confidence is identified, the proximity detector 444 may report a verified proximity to one or more small cells.

In other aspects of the embodiments, it is noted that the UE device 100 may perform periodic searches for small cells which are not associated with fingerprints. Further, the UE 100 may perform periodic searches for small cells which are associated with fingerprints, depending upon the level of accuracy in the proximity detection algorithms performed by the proximity detector 444. In this context, a periodic search is likely to involve a full band scan including a read of necessary system information from small cells which are identified, to decide whether the small cells are valid members of certain closed groups, for example.

Typically, this search would be done using both the modems 420 and 430, for the respective small cells or closed subscriber group cells of each. For example, a search performed by the modem 420 may identify small cells associated with the modem 430, but ignore those small cells, because they does not match subscriber information for the first service associated with the modem 420. Thus, each periodic search may be a power intensive and slow operation. According to aspects of the embodiments described herein, a single or combined small cell (or macro cell) search may be performed for both of the modems 420 and 430 by either one of the modems 420 and 430.

Similar to a periodic search, a user or manually triggered small cell search requires a full scan combined with necessary small cell readings. Such searches can also benefit from combining the results found in a scan conducted by the modem 420 and sharing the results with the modem 430, especially if a manual search on the modem 430 is to be conducted immediately afterwards. The results of a manual scan on one modem may be cached in the UE device 100 for a limited time, so that a full scan by the second modem can be avoided if the delay between the two scans in limited.

As noted above, unlike DSDS mode UE devices, DSDA mode UE devices have two independent RF front end chains. In this case, if a first modem is active and busy while a second modem is idle, the second modem may be able to improve or update proximity detection data by performing additional measurements, if the first modem finds a low level proximity match for a fingerprinted small cell. Here, it is noted that, while the first modem is active and busy, it is difficult for the first modem to perform non-scheduled measurements to improve proximity detection confidence without affecting an ongoing call, for example. However, as the second modem is idle, the capability of second modem can be used to gather additional measurements and improve proximity detection for the first modem without any impact on the ongoing call of the first modem.

In other aspects, it is noted that handoffs to CSG cells (and other small cells) during dedicated connections (e.g., UMTS Cell DCH state) are controlled by the network as part of a multi-stage process. When a UE device detects it is in proximity to a fingerprinted CSG cell, it may report this to the network via protocol signaling. This proximity detection may be more or less accurate depending on the available measurements used to determine proximity. The network then requests measurements on the target CSG cell, which may involve configuring the UE device with a gap pattern during which it is able to perform measurements to impact peak data throughput rates for an on-going data call. However, in case of poor proximity (e.g., stemming from poor proximity detection) to the CSG cell, the UE device may perform measurements on the CSG cell for an extended period before the UE device is actually close enough for the handoff.

When the network determines that the CSG cell strength meets the criteria for handoff, it will also require the UE device to acquire system information on the target CSG cell to confirm the cell identity. This acquisition of system information on the target CSG cell is performed during autonomous gaps generated by the UE device. Autonomously generated gaps will impact any on-going data transfer and, in the case of a UMTS circuit switched voice call, may cause drop-out of the audio in the source cell while system information is being acquired in the target CSG cell. Thus, this cell identity acquisition may occur several times without the UE device actually finding the target CSG cell unless proximity detection is very accurate.

To address these issues, aspects of the embodiments described herein may include certain processes to assist with handoffs to CSG and other small cells. For example, while a first modem is active and second modem is idle and after a loose proximity is detected but before the UE device indicates this to the network, the UE device may use the second RF front end associated with the second modem to attempt to measure system information on the CSG cell. Only once the target CSG cell is measured (above a set threshold) should the network be informed of proximity, thereby minimizing the time during which measurement gaps would be configured by the network.

In another case, while a first modem is active and second modem is idle, when the network requests the UE device to acquire system information, instead of autonomously creating gaps in which to read system information on the target CSG cell, the UE device may make use of the second modem to read the system information in the target cell, thereby avoiding any interruption in operation on the active modem.

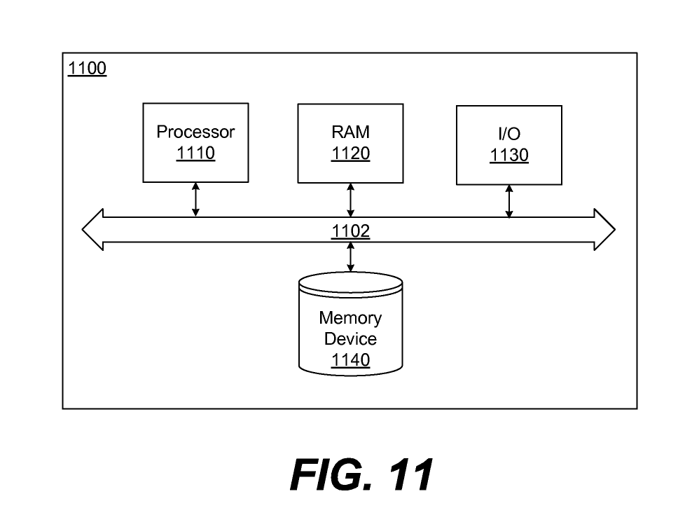

FIG. 11 illustrates an example schematic block diagram of a computing architecture 1100 which may be employed by the UE device 100 described herein according to various embodiments. In various embodiments, the general- or specific-purpose processing circuits described herein may be implemented, at least in part, by the computing architecture 1100. The computing architecture 1100 may be embodied, in part, using one or more elements of a mixed general- or specific-purpose computer, processor, or processing circuit. The computing architecture 1100 includes a processor 1110, a Random Access Memory (RAM) 1120, an Input Output (I/O) interface 1130, and a memory device 1140. The elements of computing architecture 1100 are communicatively coupled via a local interface 1102. The elements of the computing architecture 1100 are not intended to be limiting in nature, as the architecture may omit elements or include additional or alternative elements.

In various embodiments, the processor 1110 may be embodied as a general purpose arithmetic processor, a state machine, an ASIC, or a field programmable gate array (FPGA), for example, among other processing circuits. The processor 1110 may include one or more circuits, one or more microprocessors, ASICs, dedicated hardware, or any combination thereof. In certain aspects and embodiments, the processor 1110 is configured to execute one or more software modules which may be stored, for example, on the memory device 1140. In certain embodiments, the processes illustrated in FIGS. 5-10 may be implemented or executed by the processor 1110 according to instructions stored on the memory device 1140.

The RAM 1120 may include or be embodied as any random access and read only memory devices that store computer-readable instructions to be executed by the processor 1110. The memory device 1140 stores computer-readable instructions thereon that, when executed by the processor 1110, direct the processor 1110 to execute various aspects of the embodiments described herein.

As a non-limiting example group, the memory device 1140 may include one or more non-transitory memory devices, such as an optical disc, a magnetic disc, a semiconductor memory (i.e., a semiconductor, floating gate, or similar flash based memory), a magnetic tape memory, a removable memory, combinations thereof, or any other known non-transitory memory device or means for storing computer-readable instructions. The I/O interface 1130 includes device input and output interfaces, such as keyboard, pointing device, display, communication, and/or other interfaces. The one or more local interfaces 1102 electrically and communicatively couple the processor 1110, the RAM 1120, I/O interface 1130, and the memory device 1140, so that data and instructions may be communicated among them.

In certain aspects, the processor 1110 is configured to retrieve computer-readable instructions and data stored on the memory device 1140 and/or other storage means, and copy the computer-readable instructions to the RAM 1120 for execution. The processor 1110 is further configured to execute the computer-readable instructions to implement various aspects and features of the embodiments described herein. For example, the processor 1110 may be adapted or configured to execute the processes described illustrated in FIGS. 5-10. In embodiments where the processor 1110 includes a state machine or ASIC, the processor 1110 may include internal memory and registers for maintenance of data being processed.

The flowchart or process diagrams of FIGS. 5-10 are representative of certain processes, functionality, and operations of embodiments described herein. Each block may represent one or a combination of steps or executions in a process. Alternatively or additionally, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as the processor 1110. The machine code may be converted from the source code, etc. Further, each block may represent, or be connected with, a circuit or a number of interconnected circuits to implement a certain logical function or process step.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Therefore, at least the following is claimed:

1. A method for subscriber group fingerprinting, comprising:
establishing a first communication link with a first macro cell for a first communications service;
establishing a second communication link with a second macro cell for a second communications service;
measuring an access neighborhood of the first communications service;
measuring an access neighborhood of the second communications service; and
generating, with a processing circuit, a fingerprint for a small cell based on the access neighborhood of the first communications service and the access neighborhood of the second communications service.

2. The method according to claim 1, further comprising:
receiving a command to select the small cell; and
generating the fingerprint for the small cell in response to the command.

3. The method according to claim 1, further comprising, detecting proximity to the small cell by comparing the access neighborhood of the first communications service and the access neighborhood of the second communications service with the fingerprint for the small cell.

4. The method according to claim 3, further comprising, based on the proximity to the small cell, prompting a search for the small cell.

5. The method according to claim 3, further comprising, based on the proximity to the small cell, prompting a search for the small cell and handing off the first communication link to the small cell.

6. The method according to claim 1, wherein measuring the access neighborhood of the first communications service comprises measuring access characteristics associated with the first macro cell and neighboring macro cells of the first communications service.

7. The method according to claim 6, wherein measuring the access neighborhood of the second communications service comprises measuring access characteristics associated with the second macro cell and neighboring macro cells of the second communications service.

8. The method according to claim 7, wherein the fingerprint for the small cell includes a small cell identifier, an identifier of the first communications service, the access characteristics associated with the first macro cell and the neighboring macro cells of the first communications service, and the access characteristics associated with the second macro cell and the neighboring macro cells of the second communications service.

9. A device for subscriber group fingerprinting, comprising:
a first modem that establishes a first communication link with a first macro cell for a first communications service and measures an access neighborhood of the first communications service;
a second modem that establishes a second communication link with a second macro cell for a second communications service and measures an access neighborhood of the second communications service; and
a processing circuit that generates a fingerprint for a small cell for the first communications service based on the access neighborhood of the first communications service and the access neighborhood of the second communications service.

10. The device according to claim 9, wherein the processing circuit further detects proximity to the small cell by comparing the access neighborhood of the first communications service and the access neighborhood of the second communications service with the fingerprint for the small cell.

11. The device according to claim 10, wherein the processing circuit further prompts a search for the small cell and hands off the first communication link to the small cell based on the proximity to the small cell.

12. The device according to claim 9, wherein the first modem further measures access characteristics associated with the first macro cell and neighboring macro cells of the first communications service.

13. The device according to claim 12, wherein the second modem further measures access characteristics associated with the second macro cell and neighboring macro cells of the second communications service.

14. The device according to claim 13, wherein the fingerprint for the small cell includes a small cell identifier, an identifier of the first communications service, the access characteristics associated with the first macro cell and the neighboring macro cells of the first communications service, and the access characteristics associated with the second macro cell and the neighboring macro cells of the second communications service.

15. A method for subscriber group fingerprinting, comprising:
establishing, with a first modem, a first communication link with a first macro cell for a first communications service;
measuring an access neighborhood of the first communications service; and
detecting, with a processing circuit, proximity to a small cell for a second communications service by comparing the access neighborhood of the first communications service with a fingerprint for the small cell, the fingerprint for the small cell including attributes related to the access neighborhood of the first communications service and attributes related to an access neighborhood of the second communications service.

16. The method according to claim 15, further comprising, based on the proximity to the small cell, prompting a second modem to search for the small cell.

17. The method according to claim 16, further comprising requesting, with the second modem, admission to operate a radio frequency (RF) front end.

18. The method according to claim 17, further comprising suspending the first modem and admitting the second modem; and
setting up, with the second modem, a second communications link with the small cell for the second communications service.

19. The method according to claim 18, further comprising, after admitting the second modem and before setting up the second communications link, verifying the proximity to the small cell.

20. The method according to claim 19, further comprising, when proximity to the small cell cannot be validated, searching for the small cell and setting up the second communications link with the small cell.
